(19) United States
(12) Patent Application Publication
(10) Pub. No.: US 2011/0053015 A1
(43) Pub. Date: Mar. 3, 2011

(54) Control Method for a Fuel Cell System and Fuel Cell System

(75) Inventors: Hans-Frieder Walz, Bad Ueberkingen (DE); Horst Michels, Melsungen (DE); Patrick Bachinger, Guibingen (DE); Joerg Schuetz, Ludwigsburg (DE); Clemens Boegershausen, Aichwald (DE); Meenakshi Sundaresan, Kirchheim/Teck (DE); Herbert Schulze, Stuttgart (DE)

(73) Assignee: DAIMLER AG

(21) Appl. No.: 12/933,664

(22) PCT Filed: Mar. 13, 2009
(86) PCT No.: PCT/EP09/01837

§ 371 Date: Nov. 19, 2010

(30) Foreign Application Priority Data
Mar. 20, 2008 (DE) 10 2008 015 344.3

(51) Int. Cl. H01M 8/04; H01M 8/06

(52) U.S. Cl. 429/415; 429/444

(57) ABSTRACT

In a method for controlling a fuel cell system that is designed to react a fuel with an oxidant, the fuel cell system can be switched between an idle condition and an active operating condition. In the idle condition, energy is supplied to an energy consumer, at least in part, from an energy storage device, and the fuel is moved actively within the fuel cell system.

### BACKGROUND AND SUMMARY OF THE INVENTION

This application is a national stage of PCT International Application No. PCT/EP2009/001837, filed Mar. 13, 2009, which claims priority under 35 U.S.C. §119 to German Patent Application No. 10 2008 015 344.3, filed Mar. 20, 2008, the entire disclosure of which is herein expressly incorporated by reference.

The invention concerns a control method for a fuel cell system for supplying energy to a consumer, the fuel cell system being designed to bring about a reaction between a fuel and an oxidant, such that the fuel cell system can be switched between an idle condition and an active operating condition, and such that during the said idle condition energy is supplied to the consumer, for the most part or entirely, by an energy storage device. The invention also concerns a fuel cell system for implementing the said control method.

Fuel cell systems are energy supply units which convert chemical energy to electrical energy by an electrochemical process. Fuel cell systems usually comprise one or more fuel cells which have an anode zone and a cathode zone, separated from one another by a membrane. The fuel is passed through the anode zone and the oxidant through the cathode zone, whereas the membrane allows proton migration between the said zones and thereby enables the reactants to react in order to generate electrical energy.

When fuel cell systems are used in vehicles, estimates have shown that to achieve high energy efficiency it is advantageous, for example during waiting periods, to arrest the electrochemical process and provide the energy supply from an energy storage unit. Such fuel cell systems with energy storage devices are also known as hybrid systems.

For example Published U.S. patent application Ser. No. 2007/0054165 A1, which can be regarded as related prior art, describes a fuel cell system which can be switched between an active operating condition in which the fuel cells produce energy for a drivetrain, and an idle condition in which the electrochemical process is deactivated. In the document it is stated that in the idle condition operating conditions can arise which make it more difficult to re-start the fuel cells, so that for example the production of energy may be delayed or the voltage reduced. As a counter-strategy it is proposed that the fuel cell systems or their fuel cells should be switched intermittently from the idle condition to the normal, active condition.

One object of the present invention is to provide a control method for a fuel cell system and a correspondingly designed fuel cell system, with an improved strategy for controlling the fuel cell system in the idle condition.

This and other objects and advantages are achieved by the control method for a fuel cell system according to the invention, which method is suitable and/or designed for the supply of energy to a consumer. The term ‘consumer’ should preferably be understood in a general sense, as referring to a consumer system, in particular a vehicle with secondary consumers such as fluid flow machines, lighting units, etc., as well as one or more main consumers such as a drive motor.

The fuel cell system is designed to bring about a reaction between a fuel, preferably hydrogen, and an oxidant, preferably oxygen and in particular ambient air.

Primarily to increase the energy efficiency, but for other reasons as well, the fuel cell system can be switched between an idle condition and an active operating condition. The active condition is preferably chosen when the consumer is operating a high load, in particular when a vehicle, as the consumer, is supplying the drive motor with energy. In the idle condition the consumer is supplied with energy, for the most part or even entirely, from an energy storage device. Overall, the generation of energy or power by the fuel cell system in its idle condition is lower than the generation of power in its active condition.

In accordance with the invention, in the idle condition the fuel is moved actively in the fuel cell system, in particular in the fuel cells.

The invention takes into consideration that in the idle condition of the fuel cell system (in particular, its fuel cells), a situation can arise in which the ability of the fuel cell system to be restarted is reduced and/or the life of the fuel cell system, in particular its fuel cells, is affected adversely. To avoid negative consequences of the idle condition, as a divergence from the known prior art it is proposed that during the idle condition the fuel is moved actively in the fuel cell system, in particular its fuel cells.

This surprisingly simple measure can lead to a number of advantages: in the first place, too wide a scatter of the operating voltages of the various fuel cells in the fuel cell system can be avoided, since the operating conditions relating to reactant distribution are homogenized. A further possible advantage is that the reactant distribution in the fuel cell system is adjusted in such manner as to enable good or even optimum conditions for re-starting or changing from the idle to the active condition. Furthermore, the internal humidification of the fuel cells, in particular their membranes, can be controlled. By virtue of the active movement of one or both reactants accumulations of fuel, especially hydrogen, during the idle condition are avoided. Another advantage, which can be used optionally, is that condensate formation or accumulation in the fuel cells is avoided due to a drying effect by virtue of the reactant movement, in particular the movement of the oxidant.

The fuel cell system according to the invention comprises a first flow machine, preferably designed as a compressor, which is arranged and/or designed so as to compress and/or accelerate the oxidant. The first flow machine is preferably operated electrically. Moreover, in addition or alternatively, the fuel cell system may have a second flow machine, which is designed and/or arranged so as to compress and/or accelerate the fuel. In this version the fuel is moved during the idle condition by actuating the second flow machine.

It is preferably provided that the second flow machine is arranged in a recirculation branch of the anode gas supply, i.e., in terms of the flow connected in a return line between the anode outlet and the anode inlet.

In a particular embodiment of the invention, continuous ventilation of the fuel is carried out in the idle condition—optionally with different delivery rates or rotation speeds of the flow machines. In a preferred design of the invention, during the idle condition, the second flow machine is operated only intermittently, in a pulsed and/or temporary manner.

During this it is preferably provided that the second flow machine is operated with a power and/or rotation speed and/or delivery rate which is lower than the power or rotation speed during the active operating condition. In this way, therefore, intentionally only an energy-saving, reduced recirculation of the reactant is operated, in order to compensate the negative consequences of the idle condition and at the same time not impair the energy efficiency.

In the idle condition it is preferably provided that no energy conversion from chemical to electrical energy takes place. In other embodiments it is also possible that due to the circulation a certain amount of energy conversion is unavoidable, but it is then preferably provided that the energy converted is not transferred to the energy storage device and/or the consumer, and/or that the power generated in the idle condition is less than 20%, preferably less than 10% and in particular less than 5% of the power, in particular the nominal or maximum power, in the operating condition.

In a particularly preferred embodiment the control method is intended for a fuel cell system designed as a mobile energy supply, preferably in a vehicle for supplying the drivetrain with drive energy.

In a control-technological implementation of the invention it is proposed that the fuel cell system is switched to the idle condition when one, or an arbitrary selection, or all of the following conditions are fulfilled:
A: The battery system is ready for operation and has no defects.
B: No fuel cell defect is active, i.e., there is no defect in the fuel cell system.
C: The charging condition of the energy supply device is higher than a charging condition limit value, i.e., the energy storage device is charged to above the said charging condition limit value.
D: The power at an inverter which converts the electric power of the fuel cell system to an alternating current for supplying a principal load, is lower than a first power value.
E: The actual principal load current is lower than a first current limit value, i.e., the power taken up by the principal load, for example the drivetrain of a vehicle, is lower than a power limit.
F: The battery temperature is lower than a first temperature limit value.
G: The cooling fluid temperature is higher than a second temperature limit value, i.e., the fuel cell system is not switched to its idle condition during its warm-up phase, in order to reach a significantly high operating temperature, for example above 80° C.
H: No battery calibration is taking place.
I: The time during which the idle condition is not engaged is longer than a time limit value, i.e., the idle condition is not activated until after a predefined waiting interval.
J: The rotation speed of the first flow machine is lower than a speed limit value.
K: The speed of the vehicle is lower than a predetermined speed value.

It is also possible for these, or additional conditions to be cascaded or graded in various priority levels.

In a further embodiment of the invention, the fuel cell system comprises a fuel cell device with at least one fuel cell, preferably with more than 100 fuel cells which, in particular, are arranged in stacks. In addition, the fuel cell system comprises an energy storage device, for example in the form of a chargeable battery, accumulator or capacitance. The energy storage device is preferably designed as a high-voltage unit with a working voltage higher than 80 V, and preferably higher than 100 V.

To control the fuel cell system a control unit is provided, which can optionally be made as a separate control unit or as an integral part of a master control device. In the context of the invention it is proposed that the control unit is designed in terms of program and/or switching technology to control the fuel cell system in accordance with the control method just described and in accordance with any of the preceding requirements.

The fuel cell system is preferably designed as a mobile fuel cell system, in particular for use in a vehicle for supplying the drive energy.

Other objects, advantages and novel features of the present invention will become apparent from the following detailed description of the invention when considered in conjunction with the accompanying drawings.

### BRIEF DESCRIPTION OF THE DRAWINGS

FIG. 1: Schematic block diagram of a fuel cell system, as an example embodiment of the invention;

FIG. 2: The fuel cell system of FIG. 1 with further details, similarly represented;

FIG. 3: Schematic flow diagram to illustrate a control method for controlling the fuel cell system of FIGS. 1 and 2;

FIG. 4: Schematic flow diagram showing a more detailed explanation of step A1 in FIG. 3; and

FIG. 5: Schematic flow diagram showing a more detailed explanation of step A7 in FIG. 3.

### DETAILED DESCRIPTION OF THE DRAWINGS

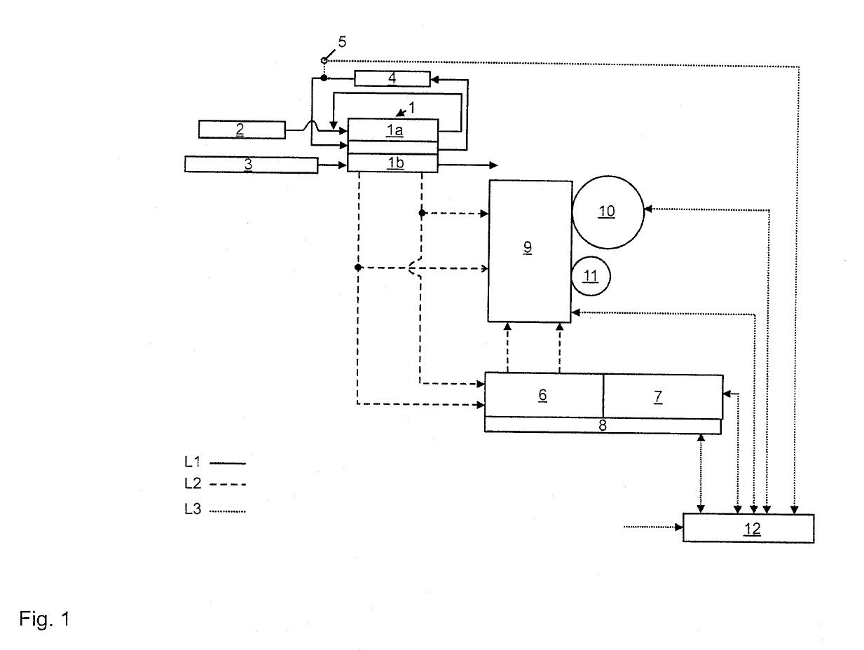

FIG. 1 shows a schematic representation of a fuel cell system, which can be used for example in a vehicle to supply the drivetrain with energy.

The fuel cell system comprises a fuel cell stack 1 with a number of fuel cells, each fuel cell of the fuel cell stack 1 having an anode zone 1a and a cathode zone 1b.

The fuel cell system has a hydrogen supply 2 in the form for example of a hydrogen tank or a reformer, which feeds the anode zone 1a of the fuel cell stack 1 with hydrogen.

An oxidant supply 3 is designed to supply the cathode zones 1b of the fuel cell stack 1 with an oxidant, in particular ambient air. To cool the fuel cell stack 1 the fuel cell system also comprises a cooling water supply 4. A sensor unit 5 monitors the temperature of the cooling water.

The power outputs of the fuel cell stack 1 are connected, on the one hand, to a DC/DC converter 6 and, parallel to this, with an inverter 9. The DC/DC converter 6 transforms the applied voltage of the fuel cell stack 1 and supplies an energy storage device in the form of a high-voltage battery 7. The DC/DC converter 6 and the high-voltage battery 7 have a second cooling system 8. In the inverter 9 the electric power of the fuel cell stack 1 is converted to alternating voltage or current, with which a drive motor 10 and auxiliary components—denoted in summary fashion by the index 11—are supplied. The high-voltage battery 7 constitutes a second and/or alternative source of energy for supplying the drive motor 10 and/or the auxiliary components 11. For the control of the fuel cell system a control unit 12 is provided, which receives status signals from the components of the fuel cell system as inputs and which emits control signals. In FIG. 1 material flows, i.e., in particular gas and liquid flows are indicated by continuous lines L1, electric power flows by heavy broken lines L2, and signal flows by dotted lines L3.

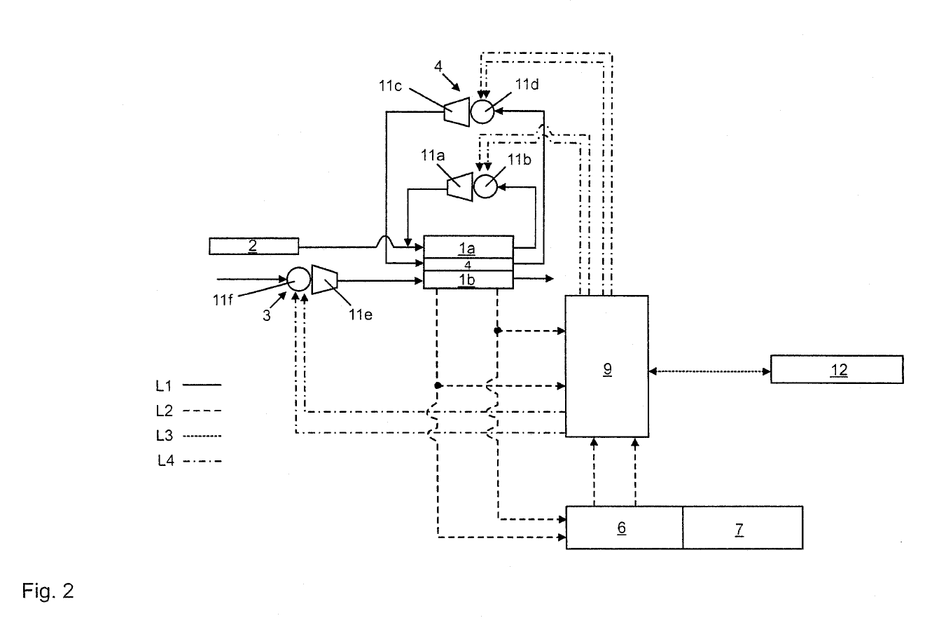

FIG. 2 shows a more detailed representation of the fuel cell system of FIG. 1, in particular the auxiliary components 11. A first auxiliary component in the form of a fan 11a is arranged in a recirculation branch, which returns unused fuel from the anode outlet to the anode inlet. The fan 11a is powered by a motor 11b.

Another auxiliary component is the cooling liquid pump 11c, which is driven by a motor 11d. The air supply 3 has a compressor 11e powered by an electric motor 11f. The auxiliary components or their motors are supplied with alternating current L4 (shown as dot-dash lines) by the inverter 9, which is supplied directly from the fuel cell stack 1 and/or by a high-voltage battery 7 via the DC/DC converter 6.

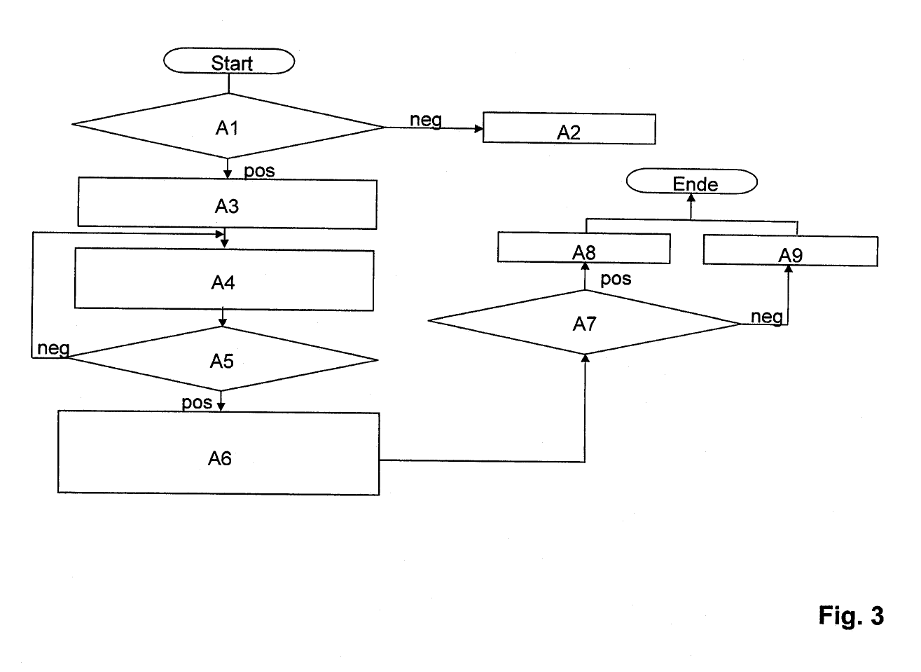

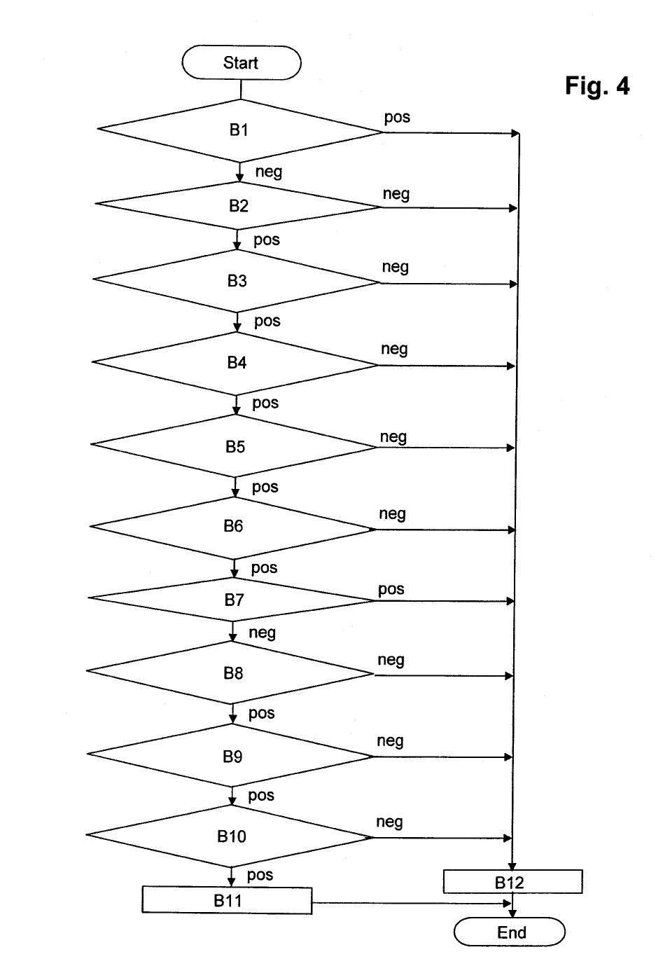

FIG. 3 shows a schematic flow diagram of a method for controlling the fuel cell system represented in the preceding figures, as an example embodiment of the invention. After the start of the process, in step A1 it is checked whether the conditions explained later in connection with FIG. 4 are fulfilled, in particular fulfilled completely. If those conditions are not fulfilled, then in accordance with step A2 switching of the fuel cell system into an idle condition is prevented.

On switching to the idle condition, according to step A3 the control unit 12 (FIG. 2) switches at least the compressor unit 11f into a stop mode, i.e., its rotation speed is reduced to zero revolutions per minute.

In accordance with step A4 the DC/DC converter 6 keeps the fuel cell stack 1 within a specified voltage range. The lower limit of this voltage range is determined by the limit used by the auxiliary aggregates of the vehicle and the fuel cell system which are still operating. The DC/DC converter 6 is also used in order, in the stop mode, to set the voltage between the fuel cell stack 1 and the high-voltage battery 7 to values such that the current of the fuel cell stack 1 is zero amperes or very close thereto, for example less than 10 amperes in absolute value.

In step A5 it is checked whether a predetermined time interval has lapsed. If so, intermittent operation in which the compressor motor 11f is activated, is commenced. During this activation the delivery power of the compressor motor 11f is raised to a low level, in particular to a level lower than the level in normal operation, and held there for a predetermined time in accordance with step A6. During the idle condition the compressor motor 11f and the other auxiliary components 11 are supplied with energy from the high-voltage battery 7. The fan motor 11b remains activated throughout the idle condition, but also at a reduced speed. In step A7 it is checked whether conditions that demand the termination of the idle condition exist.

FIG. 4 is a flow diagram which shows in more detailed form the conditions, linked by a logical AND function, all of which have to be fulfilled for the fuel cell system to change to its idle condition (step B11). If even one of these conditions is not fulfilled, switching into the idle condition is prevented in accordance with step B12.

In step B1 is it checked:
whether the fuel cell system is NOT working in a purely battery mode,
whether the fuel cell system is NOT working in a fuel cell mode, i.e., one in which the only energy supply is the fuel cell stack 1 and the traction battery 7 is not contributing to the energy supply, and
whether a fuel cell system defect has NOT occurred.

In step B2 it is checked:
whether the charge status of the battery is higher than a specified value.

In step B3 it is checked:
whether the power at the inverter 6 is lower than a specified value.

In step B4 it is checked:
whether the current demand for the drive motor is lower than a specified value.

In step B5 it is checked:
whether the temperature of the high-voltage battery 7 is lower than a specified value.

In step B6 it is checked:
whether the temperature of the cooling liquid is higher than a specified value.

In step B7 it is checked:
whether a battery calibration is not active.

In step B8 it is checked:
whether the time between each entry into the idle condition is longer than a specified range.

In step B9 it is checked:
whether the compressor speed is lower than a specified value.

In step B10 it must be checked:
whether the speed of the vehicle is lower than a specified value.

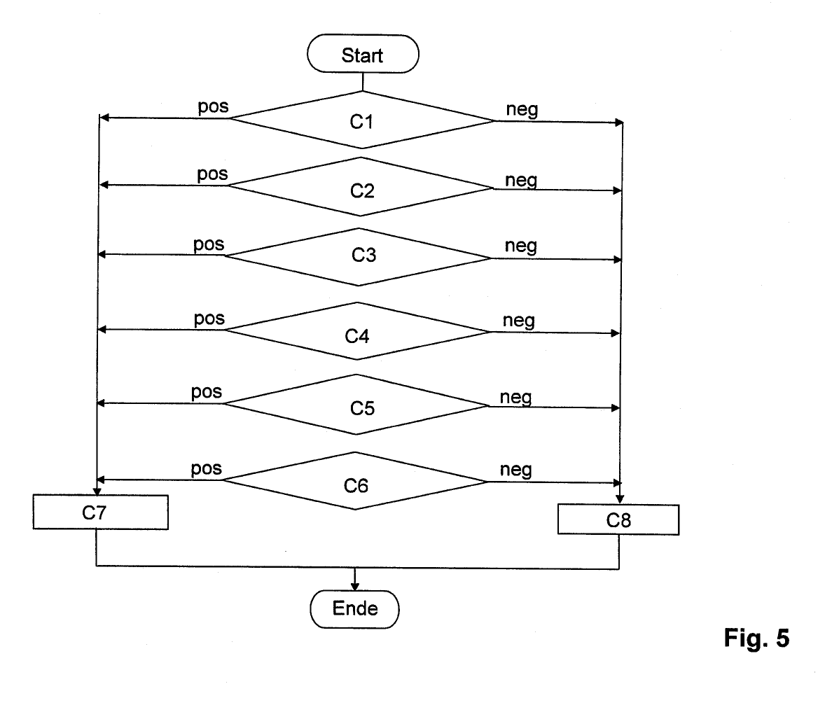

FIG. 5 shows, in the form of a flow diagram, the steps needed in order to terminate the idle condition in accordance with step A7 (FIG. 3). The steps shown are linked with one another via a logical OR function, so that any one of the steps can trigger a change from the idle to the active condition in accordance with step C7. Otherwise, the fuel cell system remains in the idle condition in accordance with step C8.

In step C1 it is checked:
whether the charging status of the high voltage battery is lower than a specified value.

In step C2 it is checked:
whether the load on the inverter due to the auxiliary components is higher than a specified value.

In step C3 it is checked:
whether the electric power taken up by the drive motor is higher than a specified value.

In step C4 it is checked:
whether the battery temperature is higher than a specified value.

In step C5 it is checked:
whether the fuel cell system is indicating a system error.

In step C6 it is checked:
whether the ignition is switched off.

In summary, the invention discloses possible versions of a control method which, during idling, suppresses an unacceptably large spread of the operating voltages of the individual fuel cells over damaging ranges and which improves the re-starting ability of the fuel cell system. This is achieved in that in or during idling the supply of reactant gases and/or adequate humidification of the fuel cells is ensured. In particular, hydrogen accumulation is avoided by forced circulation of the oxidant, preferably with the help of the compressor. Furthermore, condensate can be reduced by the drying effect of the oxidant, by the operation or intermittent operation of the compressor.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A method for controlling a fuel cell system for supplying energy to a consumer, wherein:
the fuel cell system is configured to bring about a reaction between a fuel and an oxidant;
the fuel cell system can be switched between an idle condition and an active operating condition;
in the idle condition, energy is supplied to the consumer, at least in part, from an energy storage device;
the fuel cell system comprises a first flow machine for compressing or accelerating the oxidant;
in the idle condition, movement of the oxidant is reduced by adjusting the first flow machine to a rotation speed of zero rotations per minute;
the fuel cell system comprises a second flow machine for compressing or accelerating the fuel;
in the idle condition the fuel is moved by adjusting the second flow machine to a power and/or speed lower than its power and/or speed during the active operating condition; and
a voltage between the fuel cell device and the energy storage device is set so that the current output of the fuel cell system is less than 10 amperes.

12. The method according to claim 11, wherein the second flow machine is arranged in a recirculation branch of an anode gas supply.

13. The method according to claim 11, wherein at least one of the first and second flow machines is operated intermittently in the idle condition.

14. The method according to claim 11, wherein in the idle condition, at least one of the following is true:
no conversion from chemical to electrical energy takes place; and
no converted energy is transferred to the energy storage device or to the consumer.

15. The method according to claim 11, wherein the fuel cell system is a mobile energy supply for a vehicle.

16. The method according to claim 11, wherein:
the fuel cell system is switched to its idle condition when at least one of the following conditions is fulfilled:
neither a battery mode nor a fuel cell mode is active, and there is no active fuel cell defect;
battery charge status>a charge status limit value;
power at the inverter<a first power value;
drivetrain current<a first current limit value;
battery temperature<a first temperature limit value;
a cooling liquid temperature>a first temperature limit value;
a battery calibration is not active;
time not in the idle condition>a time limit value;
speed of the first flow machine<a speed limit value; and
speed of the vehicle<a speed limit value.

17. A fuel cell system comprising:
a fuel cell device;
an energy storage device; and
a control unit; wherein,
the control unit is configured or programmed for controlling the fuel cell system in accordance with the control method according to claim 11.
